(19) United States
(12) Patent Application Publication
(10) Pub. No.: US 2023/0132730 A1
(43) Pub. Date: May 4, 2023

(54) GENERATING A USER INTERFACE FOR A USER OF AN ONLINE CONCIERGE SYSTEM IDENTIFYING A CATEGORY AND ONE OR MORE ITEMS FROM THE CATEGORY BASED FOR INCLUSION IN AN ORDER BASED ON AN ITEM INCLUDED IN THE ORDER

(71) Applicant: Maplebear Inc. (dba Instacart), San Francisco, CA (US)

(72) Inventors: Shishir Kumar Prasad, Fremont, CA (US); Natalia Botía, Sunnyvale, CA (US); Diego Goyret, Los Gatos, CA (US); Allan Stewart, Berkeley, CA (US); Douglas Mill, San Francisco, CA (US); Andrew Wong, Brooklyn, NY (US); Yao Zhou, Sunnyvale, CA (US)

(21) Appl. No.: 17/515,399

(22) Filed: Oct. 30, 2021

(51) Int. Cl. G06Q 30/06; G06F 16/2457

(52) U.S. Cl. CPC G06Q 30/0631; G06Q 30/0633; G06F 16/24573; G06F 16/24578

(57) ABSTRACT

An online concierge system maintains a taxonomy associating one or more specific items offered by a warehouse with a category. When the online concierge system receives a selection of an item from a user for inclusion in an order, the online concierge system determines a category including the selected item. From prior received orders, the online concierge system 102 identifies additional categories including one or more items included in various prior received orders. Based on cooccurrences of the category and the additional categories, the online concierge system generates scores for the additional categories. An additional category is selected based on the scores and specific items from the selected additional category are displayed via an interface for selection by the user.

### BACKGROUND

This disclosure relates generally to ordering an item through an online concierge system, and more specifically to a user interface for selecting one or more items for inclusion in an order.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in the user order in a warehouse.

To place an order through a conventional online concierge system, a user often has to navigate through long lists of items offered by a warehouse to identify a specific item to include in the order. Similarly, a user may provide multiple search queries to an online concierge system to identify specific items for the user to include in an order via the online concierge system. When a user frequently places orders through a conventional online concierge system, the user may spend a considerable amount of time navigating through listings of items offered by a warehouse or providing different search terms to the online concierge system to identify specific items for inclusion in an order. This increased time expended selecting items may decrease a frequency with which a user interacts with the online concierge system or a frequency with which the user subsequently places orders via the online concierge system.

While conventional online systems display recommendations of items to a user when the user is creating an order, online systems often provide a wide range of items to users. Providing a range of items allows an online system, such as an online concierge system, to provide users with access to a large number of items, but results in limited information about various items that can be used to recommend individual items. For example, certain items may be relevant to an item that a user has included in an order but are not displayed to the user as recommendations because the user or other users have not previously included the certain items in orders with the item included in the order. Similarly, recommending individual items to a user limits items an online system displays to the user when the user places an order, which prevents the user from identifying additional items that may be more tailored to the user's preferences or goals for the order.

### SUMMARY

An online concierge system obtains a taxonomy of items offered by a warehouse from an item catalog received from the warehouse, with different levels in the taxonomy providing different levels of specificity about items included in the levels. In various embodiments, the taxonomy identifies a category providing a generic description of multiple items and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse in various embodiments. In other embodiments, the online concierge system maintains the taxonomy and applies a trained classification model to an item catalog received from a warehouse to include different items in levels of the taxonomy, so application of the trained classification model associates specific items with categories corresponding to levels within the taxonomy.

Using the obtained taxonomy associating items with categories, the online concierge system simplifies creation of an order by a user of the online concierge system. For example, after receiving a request to create an order from a user that identifies a warehouse, the online concierge system retrieves a taxonomy for the identified warehouse or a taxonomy maintained by the online concierge system and retrieves stored categories in the obtained taxonomy. In another embodiment, when the user accesses the online concierge system, the online concierge system retrieves categories from a taxonomy maintained by the online concierge system.

When the online concierge system receives a selection of an item for inclusion in the order from the user, the online concierge system determines a category including the selected item from the taxonomy for the identified warehouse. For example, the online concierge system identifies the selected item within the taxonomy for the identified warehouse and traverses the taxonomy to a higher level than the level including the selected item, with the category for the selected item determined from the higher level. In various embodiments, the online concierge system determines the category including the selected item using any suitable information describing the selected item.

The online concierge system retrieves prior orders received by the online concierge system. In some embodiments, the online concierge system retrieves prior orders the online concierge system received within a specific time interval, such as within a threshold amount of time from a current time. In other embodiments, the online concierge system retrieves prior orders the online concierge system fulfilled within the specific time interval, such as within the threshold amount of time from the current time. The online concierge system may retrieve prior orders received from the user in some embodiments, while in other embodiments, the online concierge system retrieves prior orders identifying a location that is within a geographic region that includes a location identified by the request to create the order received from the user. Alternatively, the online concierge system retrieves prior orders received from global users of the online concierge system.

For various retrieved prior orders, the online concierge system identifies items included in a prior order and determines additional categories for items included in the prior order from the taxonomy for the identified warehouse, as further described above. In various embodiments, the online concierge system determines additional categories for items included in each retrieved prior orders, while in other embodiments the online concierge system determines categories for each of a set of the retrieved prior orders. This allows the online concierge system to determine additional categories of items that were included in different retrieved prior orders.

From the additional categories determined for items included in retrieved prior orders, the online concierge system generates scores for each of at least a set of the additional categories, with a score generated for an additional category based on cooccurrences of the additional category with the category in the retrieved prior orders. For example, the scores generated for an additional category are based on a frequency with which the additional category cooccurs with the category in the retrieved prior orders; in some embodiments, the score generated for the additional category is the frequency with which the additional category cooccurs with the category in the retrieved prior orders. In other embodiments, the score generated for an additional category is the normalized pointwise mutual information of the category and the additional category determined from the prior orders. The normalized pointwise mutual information of the category and the additional category is generated from a probability of the category and the additional category cooccurring in the prior orders, a probability of the category occurring in the prior orders, and a probability of the additional category occurring in the prior orders. For example, the normalized pointwise mutual information of the category and the additional category is determined by calculating a value as a logarithm of a ratio of the probability of the category and the additional category cooccurring in the retrieved prior orders to a product of the probability of the category occurring in the retrieved prior orders and the probability of the additional category occurring in the retrieved prior orders and dividing the value by a negative logarithm of the probability of the category and the additional category cooccurring in the retrieved prior orders. Higher normalized pointwise mutual information of the category and the additional category indicates the category and the additional category more frequently cooccur in the retrieved prior orders, while lower normalized pointwise mutual information of the category and the additional category indicates the category and the additional category less frequently cooccur in the retrieved prior orders. Embodiments using the normalized pointwise mutual information of the category and the additional category allow the online concierge system to account for both cooccurrences of categories in the retrieved prior orders as well as popularity of the category and of the additional category across the retrieved prior orders when generating the score for the additional category.

Based on the scores generated for additional categories, the online concierge system selects one or more additional categories. For example, the online concierge system selects an additional category having a maximum score, while in other examples the online concierge system selects one or more additional categories having at least a threshold score. In other embodiments, the online concierge system ranks the additional categories based on their scores and selects an additional category having a highest position in the ranking or selects additional categories having at least a threshold position in the ranking. The online concierge system accounts for categories of items included in the order when selecting additional categories in various embodiments. For example, the online concierge system filters the additional categories by removing one or more additional categories corresponding to a product included in the order and selects one or more additional categories from the filtered additional categories, as further described above. Such filtering to remove additional categories that correspond to items already included in the order prevents the online concierge system from duplicating a category that is already represented in the order when selecting one or more additional categories.

Additionally, the online concierge system accounts for the taxonomy for the identified warehouse when selecting one or more additional categories. In some embodiments, the online concierge system determines a distance between the category and one or more additional categories in the taxonomy and selects an additional category having at least a threshold distance from the category in the taxonomy, allowing the online concierge system to increase diversity of additional topics selects for the user, which provides a broader range of potential items for the user to review or include in the order. For example, the online concierge system identifies additional categories having at least a threshold position in a ranking based on their scores or having at least a threshold score and selects one or more of the identified additional categories based on distances between the category and the identified additional categories in the taxonomy. In an example, the online concierge system selects an additional category having a highest position in the ranking based on scores or having a maximum score and selects another additional category having at least a threshold distance from the category in the taxonomy and having at least a threshold score. Such a configuration allows the online concierge system to select the additional category that most often cooccurs in the retrieved prior orders with the category while selecting another additional category including items different than those in the category according to the taxonomy.

In other embodiments, when generating a score for an additional category, the score accounts for cooccurrences of the category and the additional category in retrieved prior orders and for a distance between the category and the additional category in the taxonomy. For example, the online concierge system generates a value based on the cooccurrences of the category and the additional category as further described above and generates a value based on a distance between the category and the additional category in the taxonomy. The online concierge system selects one or more additional categories based on the scores, as further described above. Such an embodiment allows the score generated for an additional category to account for both cooccurrences of items from the additional category with items from the category in the retrieved prior orders while increasing variety of additional categories selected by accounting for distances between the category and the additional categories in the taxonomy.

From the obtained taxonomy, the online concierge system identifies specific items associated with a selected additional category and displays a set of identified specific items associated with the selected additional category via an interface. In various embodiments, the interface displays an identifier of the selected additional category along a first axis and displays information describing each of the set of identified specific items along a second axis that is orthogonal to the first axis. For example, the interface displays an identifier of the selected additional category in a position along a vertical axis and displays information identifying different specific items associated with the selected category in positions along a horizontal axis that are proximate to the identifier of the selected category.

In response to receiving a selection of a specific item associated with the selected additional category, the online concierge system includes the selected specific item in an order for the user. The online concierge system then selects another additional category based on the selection of the specific item associated with the specific item, as further described above. Hence, selection of items for inclusion in the order by the user causes the online concierge system to select additional categories based on the categories of the selected items and to display items from other categories that are selected based on the categories of items that are included in orders. Rather than select individual specific items to recommend to the user based on an item the user includes in the order, the online concierge system leverages a category of an item included in the order to identify one or more other categories and displays information identifying items included in the identified one or more other categories to simplify order creation for the user. In various embodiments, the online concierge system displays identifiers of selected categories in different positions along an axis of the interface. For a selected category, the interface displays specific items associated with the selected category in different slots of a position corresponding to the selected category, with different slots of the position along an additional axis that is perpendicular to the axis of the positions. In some embodiments, the interface vertically displays information identifying selected categories and horizontally displays specific items associated with a selected category. Such a configuration allows the user to more easily generate an order from a warehouse by the interface displaying categories selected by the online concierge system based on items the user includes in the order and specific items included in the selected categories, simplifying identification and selection of specific items for inclusion in the order by the user.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a method for an online concierge system generating an interface for a user to select one or more items for inclusion in an order, according to one embodiment.

FIG. 5 is an example interface displaying items for inclusion in an order based on categories including the items, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

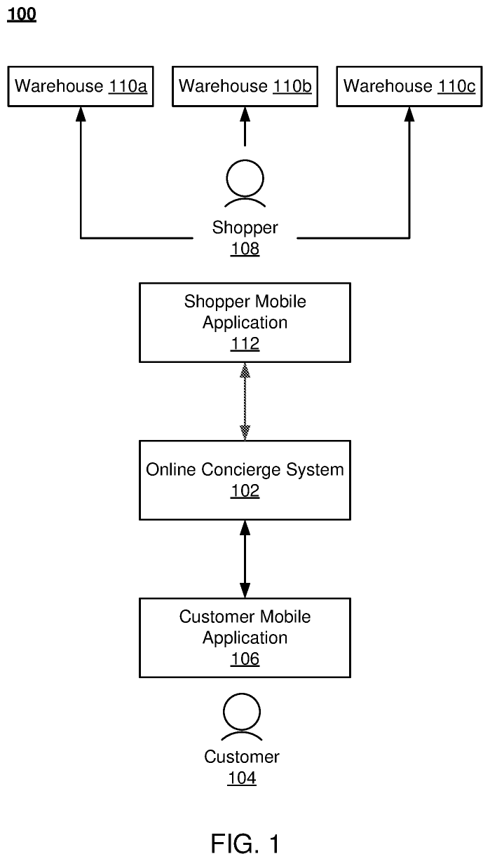

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

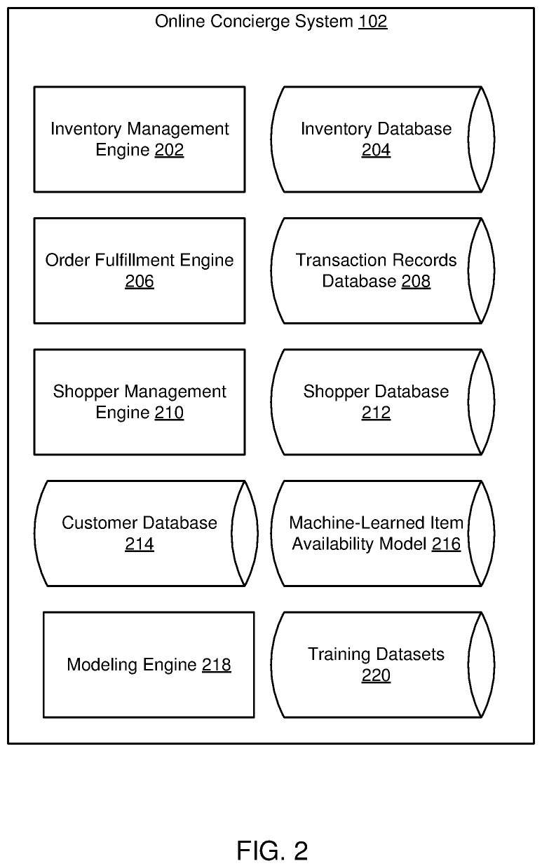

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

In various embodiments, the inventory management engine 202 maintains a taxonomy of items offered for purchase by one or more warehouses 110. For example, the inventory management engine 202 receives an item catalog from a warehouse 110 identifying items offered for purchase by the warehouse 110. From the item catalog, the inventory management engine 202 determines a taxonomy of items offered by the warehouse 110. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 110 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with categories corresponding to levels within the taxonomy

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

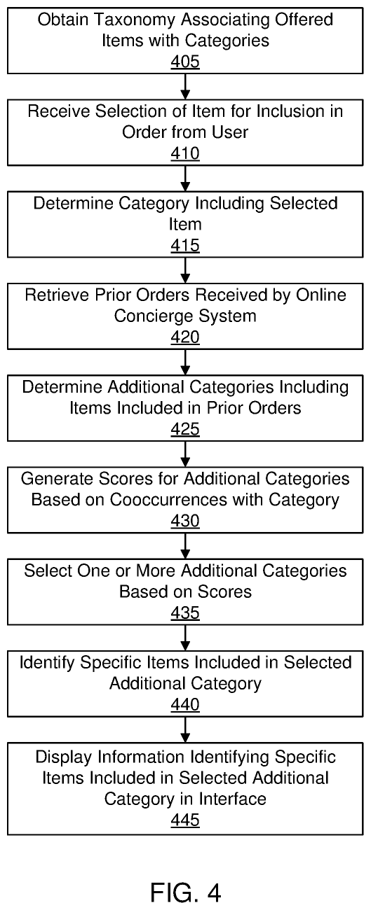

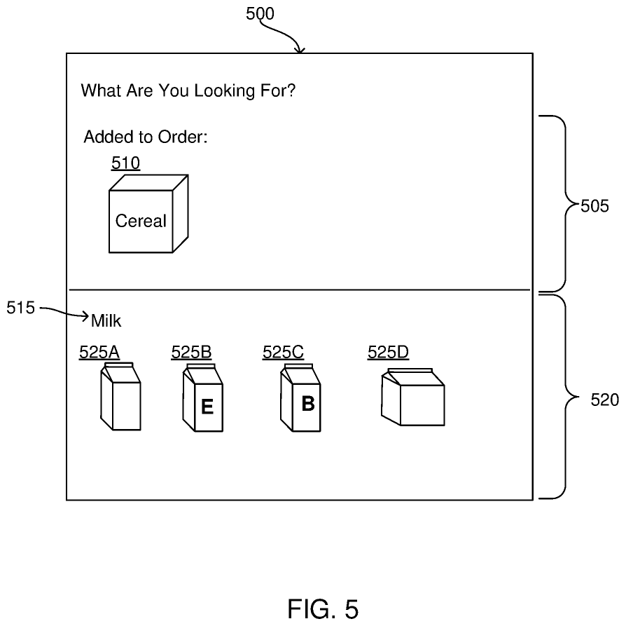

In various embodiments, the order fulfillment engine 206 leverages a taxonomy of items maintained by the inventory management engine 202 to simplify order creation for a user. In various embodiments, the order fulfillment engine 206 generates an interface for a user that identifies items included in a category selected based on an item included in an order by a user. As further described below in conjunction with FIGS. 4 and 5, when the user selects an item for inclusion in the order, the online concierge system 102 determines a category including the item from the taxonomy and leverages prior orders received by the online concierge system 102 to identify additional categories of items included in the prior orders. Based on cooccurrences of the category of the item including the item included in the order and additional categories including items in one or more prior orders, the order fulfillment engine 206 selects an additional category. Specific items included in the selected additional category are identified and displayed via the interface, allowing the user to more easily identify and select items from the selected additional category for inclusion in the order, as further described below in conjunction with FIGS. 4 and 5. Interactions with the interface allow the user to scroll through categories or to scroll through specific items associated with a selected category and to select a specific item for inclusion in an order. Hence, the interface allows the order fulfillment engine 206 to better leverage available display space to display specific items or categories likely to be relevant or likely to be selected by the user based on prior interactions, simplifying input provided by the user to create an order.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g., if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 maintains a trained purchase model that outputs a probability of the user purchasing an item. The trained purchase model accounts for times when the user previously purchased an item, such as a relative time from a previously received order including the item to a time when the model is applied, as well as attributes of the item (e.g., a type of the item, a quantity or an amount of the item that was previously purchased, a brand of the item). The trained purchase model may include a decay constant that decreases a weighting of purchases of the items over time, so purchases of the item at longer time intervals from the time when the trained purchase model is applied have lower weights than weights of purchases at the item at shorter time intervals from the time when the trained purchase model is applied. Additionally, the trained purchase model accounts for a frequency with which the user purchases an item, which increases a likelihood of the user purchasing an item if the user more frequently purchases the item. Other example factors used by the trained purchase model to determine the likelihood of a user purchasing an item include: a time interval between prior orders including the item received from the user, a frequency with which the item is included in prior orders received from the user, times when orders including the item were previously received from the user, preferences of the user, and any other suitable information. The trained purchase model may be trained using any suitable method or combination of methods (e.g., supervised learning, unsupervised learning, semi-supervised learning, etc.).

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

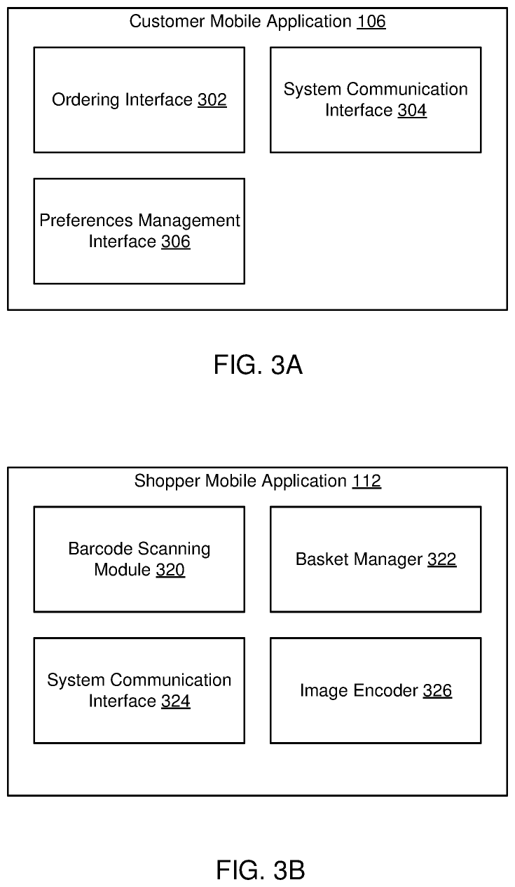

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

Selecting an Item for an Order from One or More Categories in an Interface

FIG. 4 is a flowchart of one embodiment of a method for an online concierge system 102 generating an interface for a user to select one or more items for inclusion in an order. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by the online concierge system 102 in various embodiments.

The online concierge system 102 obtains 405 a taxonomy of items offered by a warehouse 110 from an item catalog received from the warehouse 110, with different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 110 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 110 in various embodiments. In other embodiments, the online concierge system 102 maintains the taxonomy and applies a trained classification model to an item catalog received from a warehouse 110 to include different items in levels of the taxonomy, so application of the trained classification model associates specific items with categories corresponding to levels within the taxonomy.

Using the obtained taxonomy associating items with categories, the online concierge system 102 simplifies creation of an order by a user of the online concierge system 102. For example, after receiving a request to create an order from a user that identifies a warehouse 110, the online concierge system 102 retrieves a taxonomy for the identified warehouse 110 or a taxonomy maintained by the online concierge system 102 and retrieves stored categories in the obtained taxonomy. In another embodiment, when the user accesses the online concierge system 102, the online concierge system 102 retrieves categories from a taxonomy maintained by the online concierge system 102.

When the online concierge system 102 receives 410 a selection of an item for inclusion in the order from the user, the online concierge system 102 determines 415 a category including the selected item from the taxonomy for the identified warehouse 110. For example, the online concierge system 102 identifies the selected item within the taxonomy for the identified warehouse 110 and traverses the taxonomy to a higher level than the level including the selected item, with the category for the selected item determined 415 from the higher level. In various embodiments, the online concierge system 102 determines 415 the category including the selected item using any suitable information describing the selected item.

The online concierge system 102 retrieves 420 prior orders received by the online concierge system 102. In some embodiments, the online concierge system 102 retrieves 420 prior orders the online concierge system 102 received within a specific time interval, such as within a threshold amount of time from a current time. In other embodiments, the online concierge system 102 retrieves 420 prior orders the online concierge system 102 fulfilled within the specific time interval, such as within the threshold amount of time from the current time. The online concierge system 102 may retrieve 420 prior orders received from the user in some embodiments, while in other embodiments, the online concierge system 102 retrieves 420 prior orders identifying a location that is within a geographic region that includes a location identified by the request to create the order received 410 from the user. Alternatively, the online concierge system 102 retrieves 420 prior orders received from global users of the online concierge system 102.

For various retrieved prior orders, the online concierge system 102 identifies items included in a prior order and determines 425 additional categories for items included in the prior order from the taxonomy for the identified warehouse, as further described above. In various embodiments, the online concierge system 102 determines 425 additional categories for items included in each retrieved prior orders, while in other embodiments the online concierge system 120 determines 425 categories for each of a set of the retrieved prior orders. This allows the online concierge system 102 to determine additional categories of items that were included in different retrieved prior orders.

From the additional categories determined 425 for items included in retrieved prior orders, the online concierge system 102 generates 430 scores for each of at least a set of the additional categories, with a score generated 430 for an additional category based on cooccurrences of the additional category with the category in the retrieved prior orders. For example, the scores generated 430 for an additional category are based on a frequency with which the additional category cooccurs with the category in the retrieved prior orders; in some embodiments, the score generated 430 for the additional category is the frequency with which the additional category cooccurs with the category in the retrieved prior orders. In other embodiments, the score generated 430 for an additional category is the normalized pointwise mutual information of the category and the additional category determined from the prior orders. The normalized pointwise mutual information of the category and the additional category is generated 430 from a probability of the category and the additional category cooccurring in the prior orders, a probability of the category occurring in the prior orders, and a probability of the additional category occurring in the prior orders. For example, the normalized pointwise mutual information of the category and the additional category is determined by calculating a value as a logarithm of a ratio of the probability of the category and the additional category cooccurring in the retrieved prior orders to a product of the probability of the category occurring in the retrieved prior orders and the probability of the additional category occurring in the retrieved prior orders and dividing the value by a negative logarithm of the probability of the category and the additional category cooccurring in the retrieved prior orders. Higher normalized pointwise mutual information of the category and the additional category indicates the category and the additional category more frequently cooccur in the retrieved prior orders, while lower normalized pointwise mutual information of the category and the additional category indicates the category and the additional category less frequently cooccur in the retrieved prior orders. Embodiments using the normalized pointwise mutual information of the category and the additional category allow the online concierge system 102 to account for both cooccurrences of categories in the retrieved prior orders as well as popularity of the category and of the additional category across the retrieved prior orders when generating 430 the score for the additional category.

Based on the scores generated 430 for additional categories, the online concierge system 102 selects 435 one or more additional categories. For example, the online concierge system 102 selects 435 an additional category having a maximum score, while in other examples the online concierge system 102 selects 435 one or more additional categories having at least a threshold score. In other embodiments, the online concierge system 102 ranks the additional categories based on their scores and selects 435 an additional category having a highest position in the ranking or selects 435 additional categories having at least a threshold position in the ranking. The online concierge system 102 accounts for categories of items included in the order when selecting 435 additional categories in various embodiments. For example, the online concierge system 102 filters the additional categories by removing one or more additional categories corresponding to a product included in the order and selects 435 one or more additional categories from the filtered additional categories, as further described above. Such filtering to remove additional categories that correspond to items already included in the order prevents the online concierge system 102 from duplicating a category that is already represented in the order when selecting 435 one or more additional categories.

Additionally, the online concierge system 102 accounts for the taxonomy for the identified warehouse 110 when selecting 435 one or more additional categories. In some embodiments, the online concierge system 102 determines a distance between the category and one or more additional categories in the taxonomy and selects 435 an additional category having at least a threshold distance from the category in the taxonomy, allowing the online concierge system 102 to increase diversity of additional topics selects 435 for the user, which provides a broader range of potential items for the user to review or include in the order. For example, the online concierge system 102 identifies additional categories having at least a threshold position in a ranking based on their scores or having at least a threshold score and selects 435 one or more of the identified additional categories based on distances between the category and the identified additional categories in the taxonomy. In an example, the online concierge system 102 selects 435 an additional category having a highest position in the ranking based on scores or having a maximum score and selects another additional category having at least a threshold distance from the category in the taxonomy and having at least a threshold score. Such a configuration allows the online concierge system 102 to select 435 the additional category that most often cooccurs in the retrieved prior orders with the category while selecting 435 another additional category including items different than those in the category according to the taxonomy.

In other embodiments, when generating 430 a score for an additional category, the score accounts for cooccurrences of the category and the additional category in retrieved prior orders and for a distance between the category and the additional category in the taxonomy. For example, the online concierge system 102 generates a value based on the cooccurrences of the category and the additional category as further described above and generates a value based on a distance between the category and the additional category in the taxonomy. The online concierge system 102 selects 435 one or more additional categories based on the scores, as further described above. Such an embodiment allows the score generated 430 for an additional category to account for both cooccurrences of items from the additional category with items from the category in the retrieved prior orders while increasing variety of additional categories selected 435 by accounting for distances between the category and the additional categories in the taxonomy.

The online concierge system 102 selects 435 additional categories for display to the user at rates proportional to their scores in some embodiments. This allows the online concierge system 102 to account for the cooccurrences of the category and additional categories, while also providing diversity in the additional categories selected for display to the user. For example, the online concierge system 102 stores information identifying one or more additional categories that was selected 435 and displayed to the user along with information describing the order. As the user subsequently requests creation of additional orders, the online concierge system 102 uses the stored information identifying additional categories displayed to the user and determines rates at which different additional categories were displayed. The online concierge system 102 selects 435 additional categories for display so rates at which the additional categories are displayed across various requests to create orders are based on (e.g., proportional to) the scores generated 430 for the additional categories, so rates at which additional categories with higher scores are higher, while additional categories with lower scores are displayed in at least a portion of the requests to create orders.

From the obtained taxonomy, the online concierge system 102 identifies 440 specific items associated with a selected additional category and displays 445 a set of identified specific items associated with the selected additional category via an interface. In various embodiments, the interface displays an identifier of the selected additional category along a first axis and displays 445 information describing each of the set of identified specific items along a second axis that is orthogonal to the first axis. For example, the interface displays an identifier of the selected additional category in a position along a vertical axis and displays 445 information identifying different specific items associated with the selected category in positions along a horizontal axis that are proximate to the identifier of the selected category.

In various embodiments, the online concierge system 102 may account for prior inclusion of specific items within associated with the selected additional category by other users of the online concierge system 102. For example, the online concierge system 102 identifies 440 a set of specific items associated with the selected additional category received from the user that were included in at least a threshold number or a threshold percentage of orders previously received from the user (e.g., orders received by the online concierge system 102 within a specific time interval) or that were included in at least a threshold number or a threshold percentage of orders received from various users of the online concierge system 102. The online concierge system 102 may account for a location identified by the request to create the order or associated with the user when identifying 440 the set of specific items in some embodiments and identifies 425 specific items associated with the selected additional category that were included in at least at a threshold number or a threshold percentage of previously received orders (e.g., orders received by the online concierge system 102 within a specific time interval) that identified locations within a threshold distance of a location identified by the request to create the order or within a threshold distance of a location associated with the user.

In other embodiments, the online concierge system 102 applies a trained purchase model to specific items associated with the selected additional category. The trained purchase model outputs a probability of the user purchasing a specific item. The trained purchase model accounts for times when the user previously purchased a specific item, such as a relative time from a previously received order including the specific item to a time when the purchase model is applied, as well as attributes of the specific item (e.g., a type of the specific item, a quantity or an amount of the specific item that was previously purchased, a brand of the specific item). The trained purchase model may include a decay constant that decreases a weighting of purchases of specific items over time, so purchases of a specific item at longer time intervals from the time when the trained purchase model is applied have lower weights than weights of purchases at the specific item at shorter time intervals from the time when the trained purchase model is applied. Additionally, the trained purchase model accounts for a frequency with which the user purchases a specific item, which increases a likelihood of the user purchasing a specific item if the user more frequently purchases the specific item. Other example factors used by the trained purchase model to determine the likelihood of a user purchasing a specific item include: a time interval between prior orders including the specific item received from the user, a frequency with which the specific item is included in prior orders received from the user, times when orders including the specific item were previously received from the user, preferences of the user, and any other suitable information. The trained purchase model may be trained using any suitable method or combination of methods (e.g., supervised learning, unsupervised learning, semi-supervised learning, etc.). In some embodiments, the online concierge system 102 applies the trained purchase model to each combination of the user and an identified item associated with the selected additional category and ranks the specific items based on their corresponding probabilities of being purchased by the user. Based on a number of positions available for display in the interface, the online concierge system 102 displays 445 information identifying a corresponding number of identified specific items based on the ranking. This allows the online concierge system 102 to identify from the ranking specific items having higher probabilities of being purchased by the user for display in the positions of the interface available for display, optimizing use of the available display space of the interface to display 445 specific items most likely to be purchased by the user. In various embodiments, the online concierge system 102 also accounts for predicted availabilities of the specific items associated with the selected additional category by applying the machine-learned availability model 216, further described above on conjunction with FIG. 2, to specific items associated with the selected additional category. The online concierge system 102 displays 430 specific items associated with the selected additional category having at least a threshold predicted availability at the warehouse in an order based on their ranking based on probability of being purchased by the user in various embodiments. In some embodiments, the trained purchase model accounts for a difference between a probability of the user purchasing a specific item associated with the selected additional category that was included one or more previous orders and a probability of the user purchasing a different specific item associated with the selected additional category. For example, the online concierge system 102 ranks other items associated with the selected additional category based on differences between a probability of the user purchasing a specific item associated with the selected additional category and a probability of the user purchasing a specific item associated with the selected additional category that was previously purchased by the user (e.g., a specific item that was most recently purchased by the user) so specific items having smaller differences have higher positions in the ranking. The online concierge system 102 displays 445 a set of specific items having at least a threshold position in the ranking. This allows the online concierge system 102 to maximize a probability of the user purchasing a specific item associated with the selected additional category differing from a specific item associated with the selected additional category that was included in a previous order when displaying 445 information describing each of a set of specific items associated with the selected category.

The online concierge system 102 applies the machine-learned item availability model 216, further described above in conjunction with FIG. 2, to the specific items associated with the selected additional category and the warehouse 110 identified by the request to create the order, to determine a predicted availability of different specific items associated with the selected additional category at the warehouse 110 identified for fulfilling the order. In various embodiments, the online concierge system 102 identifies a group of specific items associated with the selected additional category having at least a threshold availability and ranks the specific items associated with the selected additional category of the group based on probabilities of the user purchasing each item of the group; the online concierge system 102 displays 445 information describing a set of specific items associated with the selected additional category of the group having at least a threshold probability of being purchased by the user or having at least a threshold position in a ranking based on their probabilities of being purchased by the user. In another embodiment, the online concierge system 102 ranks specific items associated with the selected additional category based on their predicted availabilities and identifies a group of specific items associated with the selected additional category having at least a threshold position in the ranking; the online concierge system 102 displays 445 information describing specific items of the group via the interface. Alternatively, the online concierge system 102 retrieves information stored in association with a specific item associated with the selected additional category that was previously purchased by the user and displays 445 one or more replacement specific items stored in association with the user for the identified specific item. The online concierge system 102 may account for probabilities of the user purchasing various replacement specific items of the set if multiple replacement specific items for an item associated with the selected additional category previously purchased by the user are stored in association with the user; for example, the online concierge system 102 displays replacement specific items stored in association with the user having at least a threshold probability of being purchased by the user or having at least a threshold predicted availability at the warehouse 110 identified by the received request to create an order.

In some embodiments, an entity associated with a specific item associated with the selected additional category provides the online concierge system 102 with compensation for displaying 445 the selected specific item associated with the selected category. Example entities associated with a specific item include a warehouse 110 from which the specific item is obtained, a manufacturer of the specific item, a brand offering the specific item, or any other suitable entity. The online concierge system 102 receives compensation from the entity for displaying 445 information describing the specific item to users via the interface. Alternatively, the online concierge system 102 receives compensation from the entity for the user including the specific item in an order and completing the order including the specific item to purchase the specific item. The online concierge system 102 may account for compensation received from one or more entities when displaying 445 information identifying one or more specific items associated with the selected additional category in various embodiments. For example, the online concierge system 102 determines expected values for various specific items associated with the selected additional category for which the online concierge system 102 receives compensation as a product of an amount of compensation received for displaying 445 information describing a specific item or for a user purchasing the specific item and a probability of the user purchasing the item. The online concierge system 102 displays 445 information identifying one or more specific items associated with the selected additional category via the interface, such as a specific item associated with the selected additional category having a maximum expected value or a specific item associated with the selected additional category having at least a threshold position in a ranking of specific items associated with the selected additional category and displays 445 information identifying one or more specific items associated with the selected additional category having at least a threshold position in the ranking. In some embodiments, the online concierge system 102 converts a probability of the user purchasing an item associated with the selected additional category and an amount of compensation the online concierge system 102 receives for displaying 445 information describing the specific item associated with the selected additional category (or for the user purchasing the specific item associated with the selected additional category) into a common unit of measurement. For example, the online concierge system 102 applies a conversion factor to the probability of the user purchasing a specific item associated with the selected additional category that converts the probability of the user purchasing the specific item associated with the selected additional category to an organic amount of compensation. Alternatively, the online concierge system 102 applies a conversion factor to the amount of compensation the online concierge system 102 receives for displaying 445 information describing the specific item associated with the selected additional category (or for the user purchasing the specific item associated with the selected category) to a compensated probability. Converting the amount of compensation received by the online concierge system 102 for displaying 445 information describing a selected additional category and the probability of the user purchasing the item into a common unit of measurement allows the online concierge system 102 to calculate a value for each specific item associated with the selected additional category, both specific items associated with the selected additional category for which the online concierge system 102 receives compensation for displaying 445 (or for the user purchasing) and specific items associated with the selected category for which the online concierge system 102 does not receive compensation for displaying 445 (or for the user purchasing). The online concierge system 102 ranks the specific items associated with the selected additional category based on their corresponding values and displays 430 information describing specific items associated with the selected additional category having at least a threshold position in the ranking. In various embodiments, the online concierge system 102 may also account for predicted availabilities of specific items associated with the selected additional category and display 445 information describing specific items associated with the selected additional category having at least the threshold position in the ranking based on values and having at least a threshold predicted availability at the warehouse 110 identified by the request to create an order. Alternatively, the online concierge system 102 selects specific items associated with the selected additional category having at least the threshold availability at the warehouse 110 and displays 445 information describing selected specific items associated with the selected additional category having at least a threshold value or having at least a threshold position in a ranking based on the values.

In response to receiving a selection of a specific item associated with the selected additional category, the online concierge system 102 includes 450 the selected specific item in an order for the user. The online concierge system 102 then selects another additional category based on the selection of the specific item associated with the specific item, as further described above. Hence, selection of items for inclusion in the order by the user causes the online concierge system 102 to select additional categories based on the categories of the selected items and to display items from other categories that are selected based on the categories of items that are included in orders. Rather than select individual specific items to recommend to the user based on an item the user includes in the order, the online concierge system 102 leverages a category of an item included in the order to identify one or more other categories and displays information identifying items included in the identified one or more other categories to simplify order creation for the user. In various embodiments, the online concierge system 102 displays identifiers of selected categories in different positions along an axis of the interface. For a selected category, the interface displays 445 specific items associated with the selected category in different slots of a position corresponding to the selected category, with different slots of the position along an additional axis that is perpendicular to the axis of the positions. In some embodiments, the interface vertically displays information identifying selected categories and horizontally displays specific items associated with a selected category. Such a configuration allows the user to more easily generate an order from a warehouse 110 by the interface displaying categories selected by the online concierge system 102 based on items the user includes in the order and specific items included in the selected categories, simplifying identification and selection of specific items for inclusion in the order by the user.

To reduce latency, the online concierge system 102 determines 425 one or more additional categories and selects 435 one or more of the additional categories for a category from which specific items are displayed via the interface when the specific items are displayed, as further described above. This allows the online concierge system 102 to reduce an amount of time to display additional categories if the user selected a specific item from the displayed category in the order. Such a reduction in latency for determining the one or more additional categories from which items are displayed simplifies use of the interface by the user, further increasing efficiency of order creation by the user.

FIG. 5 shows an example of the interface 500 displayed to a user by the online concierge system 102 for creating an order based on categories of items. The interface 500 includes an order summary region 505 including depictions or other information describing items that have been selected by the user for inclusion in the order. In the example of FIG. 5, item 510 has been selected for inclusion in the order, so a depiction of item 510 is displayed in the order summary region 505. As the user selects items for inclusion in the order, depictions or other information describing the selected items are displayed in the order summary region 505, allowing the user to readily identify the items included in the order.

When the user selects an item for inclusion in the order, such as item 510, the online concierge system 102 determines a category including the item from a taxonomy obtained for the warehouse 110. As further described above in conjunction with FIGS. 2 and 4, the taxonomy provides different levels of specificity about items included in the levels. In various embodiments, the taxonomy identifies a category and associates one or more specific items with the category. The online concierge system 102 leverages the identified category for the item 510 to identify additional specific items to display to the user through the interface 500, allowing the user to more easily review specific items and select specific items for inclusion in the order.

To leverage the category including the selected item, item 510, the online concierge system 102 retrieves prior orders received by the online concierge system 102, as further described above in conjunction with FIG. 4. For different retrieved prior orders, the online concierge system 102 identifies items included in a prior order and determines an additional category including different items included in the prior order. In some embodiments, the online concierge system 102 determines an additional category including each item included in a prior order.

For each additional category including an item included in a prior order, the online concierge system 102 generates a score based on cooccurrences of the category and the additional category in retrieved prior orders, as further described above in conjunction with FIG. 4. The score for an additional category may account for a distance between the category and the additional category in the taxonomy in some embodiments, and the score accounts for both cooccurrences of the category and the additional category in the retrieved prior orders as well as popularities of the category and the additional category in the retrieved prior orders. Based on the scores, the online concierge system 102 selects one or more additional categories and identifies specific items included in an additional category from the taxonomy. Selection of one or more additional categories and identification of specific items included in an additional category are further described above in conjunction with FIG. 4.

In the example of FIG. 5, the online concierge system 102 selects additional category 515 based on scores for additional categories including items that are included in retrieved prior orders, so the interface 500 displays information identifying additional category 515, such as a name or other description of additional category 515. In various embodiments, the interface 500 includes an item description region 520 in which with the information displaying the selected additional category 515 and information describing different specific items included in the selected additional category 515 are displayed. For example, the item description region 520 includes different positions, with each position corresponding to a selected additional category. Hence, in the example of FIG. 5, the information identifying the selected additional category 515 is displayed in a position. While FIG. 5 shows the identifier 610 of the category for the selected additional position 515 as text, in other embodiments, the identifier is an image, a combination of image and text data, or other suitable information describing a category selected by the user.

The position includes multiple slots, with each slot displaying information describing a specific item 525A, 525B, 525C, 525D (also referred to individually and collectively using reference number 525) associated with the category selected by the user. In the example of FIG. 5, different slots in the position display images corresponding to different specific items 525A, 525B, 525C, 525D associated with the category selected by the user. However, in other embodiments, any suitable information identifying specific items 525A, 525B, 525C, 525D are displayed in different slots of the position. Example information identifying a specific item 525 includes an image of the specific item 525, a price of the specific item 525, a name of the specific item 525, a title of the specific item 525, or any other suitable descriptive information allowing the user to identify the specific item 525. In various embodiments, the online concierge system 102 initially displays information identifying a set of specific items 525A, 525B, 525C, 525D in slots of the position. The online concierge system 102 determines the set of specific items 525A, 525B, 525C, 525D for which identifying information is displayed via slots of the position, as further described above in conjunction with FIG. 4. In various embodiments, the position displays information describing different specific items 525 in a determined order. For example, the online concierge system 102 ranks specific items 525 based on their availability at a warehouse identified by the user or based on their probabilities of being purchased by the user, with categories having higher availabilities or higher probabilities of being purchased by the user having higher positions in the ranking. The position for the selected additional category r displays information describing specific items 525 associated with the selected category in an order based on the ranking, with descriptions of specific items 525 having higher positions in the ranking displayed in more prominent or more readily accessible slots of the position.

In the example of FIG. 5, the position is a horizontally scrollable list including multiple slots, with each slot displaying information describing a specific item 525 associated with the category corresponding to the slot. In some embodiments, the interface 500 displays different positions that correspond to different additional categories, which are selected based on an item more recently selected for inclusion in the order by the user along a vertical axis, while displaying information describing specific items 525 horizontally. Hence, in some embodiments, the interface 500 displays information identifying categories selected by the online concierge system 102 based on an item included in the order by the user and displays information identifying specific items associated with a selected category along a second axis that is perpendicular to the first axis. Such a configuration allows the user to more easily generate an order from a warehouse 110 by leveraging items added to the order by the user to select other categories including items that are displayed to the user via the interface 500. This leverages prior inclusion of items from categories in orders to identify a category likely to include items complementing an item included in the order that are then displayed to the user via the interface 500 to simplify identification and selection of items from the identified category via the interface 500.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining a taxonomy at an online concierge system, the taxonomy associating one or more categories with one or more specific items offered for purchase by a warehouse;
receiving a request to create an order from the user, the request identifying the warehouse;
receiving a selection of a specific item for inclusion in the order;
determining a category including the specific item from the obtained taxonomy;
retrieving prior orders received by the online concierge system;
for each retrieved prior order, identifying an additional category including one or more items included in a retrieved prior order;
determining a score for each additional category, the score for the additional category based on cooccurrences of the additional category and the category in the retrieved prior orders;
selecting one or more additional categories based on the scores;
identifying specific items associated with a selected additional category by the taxonomy; and
displaying an interface identifying the selected additional category and displaying specific items associated with the selected additional category in slots displayed proximate to an identifier of the selected additional category.

2. The method of claim 1, wherein identifying the additional category including one or more items included in the retrieved prior order comprises:
identifying items included in the prior order; and
identifying the additional category as a category including an identified item included in the prior order;

3. The method of claim 1, wherein determining the score for each additional category comprises:
determining a rate at which the additional category and the category cooccur in the retrieved prior orders.

4. The method of claim 1, wherein determining the score for each additional category comprises:
determining normalized pointwise mutual information of the category and the additional category determined from the retrieved prior orders.

5. The method of claim 1, wherein determining the score for each additional category comprises:
determining a value based on a normalized pointwise mutual information of the category and the additional category determined from the retrieved prior orders;
determining an additional value based on a distance between the category and the additional category in the taxonomy; and
determining the score for the additional category as a combination of the value and the additional value.

6. The method of claim 1, wherein selecting one or more additional categories based on the scores comprises:
ranking the additional categories based on their scores; and
selecting one or more additional categories having at least a threshold position in the ranking.

7. The method of claim 1, wherein selecting one or more additional categories based on the scores comprises:
ranking the additional categories based on their scores;
selecting an additional category having at least a threshold position in the ranking and
selecting another additional category having at least the threshold position in the ranking and having at least a threshold distance from the category in the taxonomy.

8. The method of claim 1, further comprising:
receiving a selection of a specific item included in the selected additional category
for each retrieved prior order, identifying other additional categories including one or more items included in the retrieved prior order;
determining a score for each other additional category, the score for an other additional category based on cooccurrences of the additional category and the other additional category in the retrieved prior orders;
selecting one or more other additional categories based on the scores;
identifying specific items associated with a selected other additional category by the taxonomy; and
modifying the interface to identify the selected other additional category and displaying specific items associated with the selected other additional category in slots displayed proximate to an identifier of the selected other additional category.

9. The method of claim 1, wherein displaying the interface identifying the selected additional category and displaying specific items associated with the selected additional category in slots displayed proximate to the identifier of the selected additional category comprises:
determining a predicted availability of each identified specific item included in the selected additional category at the warehouse identified by the request; and
displaying identified specific items included in the selected additional category in different slots of the position, a slot in which an identified specific item included in the selected additional category is displayed based on the predicted availability of the identified specific item included in the selected additional category.

10. The method of claim 1, wherein the retrieved prior orders comprise orders previously received by the online concierge system from the user.

11. The method of claim 1, wherein the selected additional category is not a category including one or more items included in the order.

12. A computer program product comprising a non-transitory computer readable storage medium having instructions encoded thereon that, when executed by a processor, cause the processor to:
obtain a taxonomy at an online concierge system, the taxonomy associating one or more categories with one or more specific items offered for purchase by a warehouse;
receive a request to create an order from the user, the request identifying the warehouse;
receive a selection of a specific item for inclusion in the order;
determine a category including the specific item from the obtained taxonomy;
retrieve prior orders received by the online concierge system;
for each retrieved prior order, identify an additional category including one or more items included in a retrieved prior order;
determine a score for each additional category, the score for the additional category based on cooccurrences of the additional category and the category in the retrieved prior orders;
select one or more additional categories based on the scores;
identify specific items associated with a selected additional category by the taxonomy; and
display an interface identifying the selected additional category and displaying specific items associated with the selected additional category in slots displayed proximate to an identifier of the selected additional category.

13. The computer program product of claim 12, wherein identify the additional category including one or more items included in the retrieved prior order comprises:
identify items included in the prior order; and
identify the additional category as a category including an identified item included in the prior order;

14. The computer program product of claim 12, wherein determine the score for each additional category comprises:
determining a rate at which the additional category and the category cooccur in the retrieved prior orders.

15. The computer program product of claim 12, wherein determine the score for each additional category comprises:
determine normalized pointwise mutual information of the category and the additional category determined from the retrieved prior orders.

16. The computer program product of claim 12, wherein determine the score for each additional category comprises:
determine a value based on a normalized pointwise mutual information of the category and the additional category determined from the retrieved prior orders;
determine an additional value based on a distance between the category and the additional category in the taxonomy; and
determine the score for the additional category as a combination of the value and the additional value.

17. The computer program product of claim 12, wherein select one or more additional categories based on the scores comprises:
rank the additional categories based on their scores; and
select one or more additional categories having at least a threshold position in the ranking.

18. The computer program product of claim 12, wherein select one or more additional categories based on the scores comprises:
rank the additional categories based on their scores;
select an additional category having at least a threshold position in the ranking and
select another additional category having at least the threshold position in the ranking and having at least a threshold distance from the category in the taxonomy.

19. The computer program product of claim 12, wherein the non-transitory computer readable storage medium further has instructions encoded thereon that, when executed by the processor, cause the processor to:
receive a selection of a specific item included in the selected additional category
for each retrieved prior order, identify other additional categories including one or more items included in the retrieved prior order;
determine a score for each other additional category, the score for an other additional category based on cooccurrences of the additional category and the other additional category in the retrieved prior orders;
select one or more other additional categories based on the scores;
identify specific items associated with a selected other additional category by the taxonomy; and
modify the interface to identify the selected other additional category and displaying specific items associated with the selected other additional category in slots displayed proximate to an identifier of the selected other additional category.

20. The computer program product of claim 12, wherein display the interface identifying the selected additional category and displaying specific items associated with the selected additional category in slots displayed proximate to the identifier of the selected additional category comprises:
determine a predicted availability of each identified specific item included in the selected additional category at the warehouse identified by the request; and
display identified specific items included in the selected additional category in different slots of the position, a slot in which an identified specific item included in the selected additional category is displayed based on the predicted availability of the identified specific item included in the selected additional category.

21. The computer program product of claim 12, wherein the retrieved prior orders comprise orders previously received by the online concierge system from the user.

22. The computer program product of claim 12, wherein the selected additional category is not a category including one or more items included in the order.
